(19) United States
(12) Patent Application Publication
(10) Pub. No.: US 2022/0119031 A1
(43) Pub. Date: Apr. 21, 2022

(54) VEHICLE AUXILIARY CONTROL KIT

(71) Applicant: Jonathan Kermit Dodrill, Charlotte, NC (US)

(72) Inventor: Jonathan Kermit Dodrill, Charlotte, NC (US)

(21) Appl. No.: 17/505,882

(22) Filed: Oct. 20, 2021

Related U.S. Application Data
(60) Provisional application No. 63/094,573, filed on Oct. 21, 2020.

(51) Int. Cl. B62D 1/22; B62D 1/16; B60T 7/04; B60K 26/02; B60Q 1/34; B62D 65/14; B62D 63/04

(52) U.S. Cl. CPC B62D 1/22; B62D 1/16; B60T 7/04; B62D 63/04; B60Q 1/343; B62D 65/14; B60K 26/02

(57) ABSTRACT

A vehicle auxiliary control apparatus includes: an auxiliary steering assembly, including: a frame; an auxiliary steering shaft mounted for rotation in the frame; an auxiliary steering wheel mounted to the auxiliary steering shaft; first and second cable spool assemblies mounted to the auxiliary steering shaft; and first and second cable assemblies coupled to the first and second cable spool assemblies, respectively; and coupling means for coupling the first and second cable assemblies to a stock steering shaft of a motor vehicle, such that rotation of the auxiliary steering shaft causes rotation of the motor vehicle steering shaft.

### BACKGROUND OF THE INVENTION

This invention relates generally to motor vehicles and more particularly to auxiliary controls for motor vehicles.

Typical motor vehicles such as automobiles, vans, and trucks have the primary driving controls (e.g., steering wheel, accelerator pedal, and brake pedal) located on one side of the vehicle, referred to herein as the “driver side”. The opposite side of the vehicle is referred to as the “passenger side” and typically does not include any primary driving controls.

In the United States, typical vehicles have the driver seated on the left of the vehicle when viewed facing forward and the passenger seated on the right side of the vehicle. The opposite arrangement is used in vehicles in some other countries.

There is sometimes a need to operate a vehicle from the passenger side. For example, postal workers or delivery drivers can need this capability.

Prior art conversion kits exist which provide auxiliary controls located on the passenger side. However, these are typically bulky and inconvenient.

### SUMMARY

According to one aspect of the technology described herein, a vehicle auxiliary control apparatus includes: an auxiliary steering assembly, including: a frame; an auxiliary steering shaft mounted for rotation in the frame; an auxiliary steering wheel mounted to the auxiliary steering shaft; first and second cable spool assemblies mounted to the auxiliary steering shaft; and first and second cable assemblies coupled to the first and second cable spool assemblies, respectively; and coupling means for coupling the first and second cable assemblies to a stock steering shaft of a motor vehicle, such that rotation of the auxiliary steering shaft causes rotation of the motor vehicle steering shaft.

According to another aspect of the technology described herein, a method is described of providing auxiliary control of a motor vehicle of the type including a chassis riding on at least one wheel assembly which is driven by a primer mover and is provided with a brake. The method includes: providing an auxiliary steering assembly, including a frame, an auxiliary steering shaft mounted for rotation in the frame, and auxiliary steering wheel coupled to the auxiliary steering shaft, first and second cable spool assemblies mounted to the auxiliary steering shaft, and first and second cable assemblies coupled to the first and second cable spool assemblies, respectively; attaching the frame to the vehicle; coupling the cable assemblies to a stock steering shaft of the motor vehicle, in a configuration such that rotation of the auxiliary steering shaft causes rotation of the stock steering shaft.

According to another aspect of the technology described herein, a motor vehicle includes: a chassis supported on at least one wheel assembly; a steering mechanism coupled to the at least one wheel assembly; a stock steering shaft coupled to the steering mechanism; a prime mover operable to drive the at least one wheel assembly; a stock accelerator pedal assembly operable to control a power output of the prime mover; a brake operable to slow the at least one wheel assembly; a stock brake pedal assembly operable to cause operation of the brake; and an auxiliary steering assembly; including: a frame mounted to the motor vehicle; an auxiliary steering shaft mounted for rotation in the frame; an auxiliary steering wheel mounted to the auxiliary steering shaft; first and second cable spool assemblies mounted to the auxiliary steering shaft; and first and second cable assemblies, which are coupled to the first and second cable spool assemblies, respectively, and to the stock steering shaft, and a configuration such that rotation of the auxiliary steering shaft causes rotation of the stock vehicle steering shaft.

### BRIEF DESCRIPTION OF THE DRAWINGS

The invention may be best understood by reference to the following description taken in conjunction with the accompanying drawing figures, in which:

FIG. 1 is a schematic top view diagram of an exemplary motor vehicle;

FIG. 2 is a side view of an exemplary auxiliary steering assembly;

FIG. 3 is an enlarged view of a portion of the auxiliary steering assembly of FIG. 2;

FIG. 4 is another enlarged view of a portion of the auxiliary steering assembly of FIG. 2;

FIG. 5 is a schematic perspective view of a vehicle stock steering shaft having split spools attached thereto;

FIG. 6 is a schematic perspective view of an auxiliary brake control assembly;

FIG. 7 is a schematic side view of a portion of the auxiliary brake control assembly of FIG. 6;

FIG. 8 is a schematic view of an auxiliary accelerator control assembly; and

FIG. 9 is a schematic view of an auxiliary turn signal control.

### DETAILED DESCRIPTION OF THE INVENTION

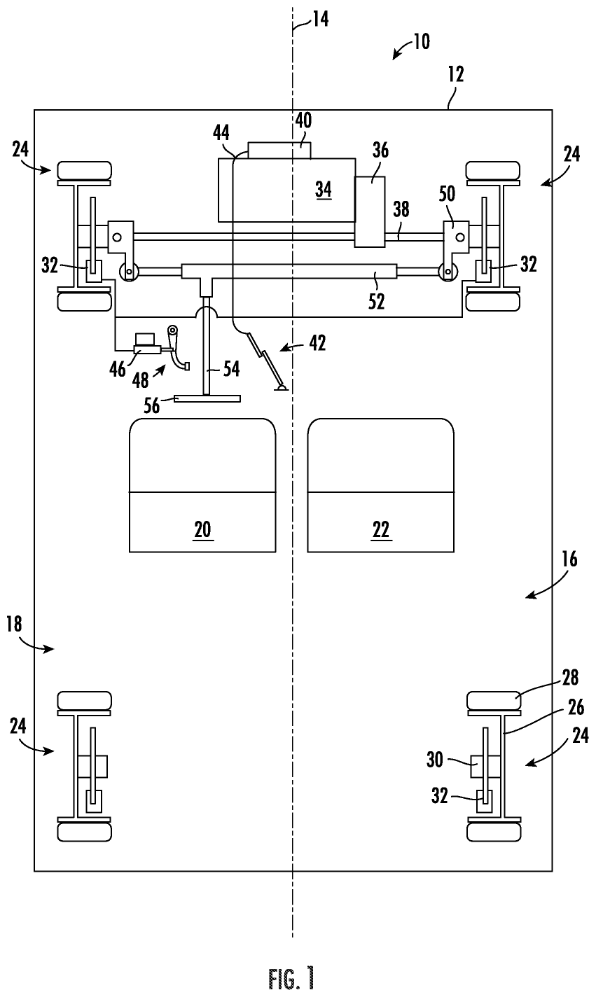

Referring to the drawings wherein identical reference numerals denote the same elements throughout the various views, FIG. 1 is a schematic diagram of a conventional motor vehicle 10 having a body 12. For reference purposes, a longitudinal axis 14 divides vehicle into a passenger side 16 and a driver side 18.

The vehicle includes a driver seat 20 and a passenger seat 22. Vehicle 10 rides on four wheel assemblies 24. In the illustrated example, each wheel assembly 24 includes a wheel 26 carrying an inflatable tire 28 mounted to a rotatable hub 30 which is provided with a brake 32. It will be understood that the motor vehicle 10 may include a greater or lesser number of wheel assemblies than illustrated. It will also be understood that each of the wheel assemblies 24 is typically coupled to the vehicle via a suspension mechanism (not shown).

The illustrated vehicle 10 is of the front wheel drive, transverse engine configuration and includes a conventional internal combustion engine 34 coupled to a transmission 36 which drives the front wheel assembly 24 through half-shafts 38. The engine 34 is one example of a suitable prime mover. It will be understood that other types of prime move could be used, such as external combustion engines, internal combustion engines of various thermodynamic cycles, electric motors, or hybrid drive systems.

The engine 34 is controlled by a fuel delivery system 40 such as a carburetor or fuel injection system. The fuel delivery system 40 is responsive to a throttle position controlled by an accelerator pedal assembly 42, for example through a mechanical connection such as the illustrated throttle cable 44, or a wired or wireless electronic control connection. Regardless of the type of prime mover used, it will be understood that the accelerator pedal assembly 42 is effective to cause a change in the power output of the prime mover. For descriptive purposes, the accelerator pedal assembly 42 may be referred to as a “stock accelerator pedal assembly”. The use of the term “stock” does not necessarily imply that the accelerator pedal assembly 42 is the one that the vehicle 10 was originally equipped with; it merely implies the accelerator pedal assembly 42 is in the “stock” location, i.e. positioned to be operated from a person in the driver seat 20.

The brakes 32 operate in response to pressurized hydraulic fluid provided by the master cylinder 46 which is coupled to a brake pedal assembly 48. For descriptive purposes, the brake pedal assembly 48 may be referred to as a “stock brake pedal assembly”. The use of the term “stock” does not necessarily imply that the brake pedal assembly 48 is the one that the vehicle 10 was originally equipped with; it merely implies the brake pedal assembly 48 is in the “stock” location, i.e. positioned to be operated from a person in the driver seat 20.

The front wheels 26 are mounted on pivoting steering knuckles 50 which are in turn connected to tie rod ends of a steering gear or mechanism such as the illustrated steering rack 52. The steering rack 52 operates in response to torque applied to a steering shaft 54 through conventional steering wheel 56. Stated another way, the steering gear is configured such that operation of the steering shaft 54 steers one or more of the wheel assemblies 24. While a front-steering vehicle is described as an example, it will be understood that rear-steer and four-wheel steered vehicles are known. For descriptive purposes, the steering shaft 54 may be referred to as a “stock steering shaft”. The use of the term “stock” does not necessarily imply that the steering shaft 54 is the one that the vehicle 10 was originally equipped with; it merely implies the steering shaft 54 is in the “stock” location, i.e. positioned to be operated from a person in the driver seat 20.

It is noted that all of the illustrated primary driving controls (e.g., accelerator pedal assembly 42, brake pedal assembly 48, and steering wheel 56) are accessible only to a person seated in the driver seat 20. As noted above, there are circumstances under which a person seated in the passenger seat 22 needs to be able to operate the primary driving controls.

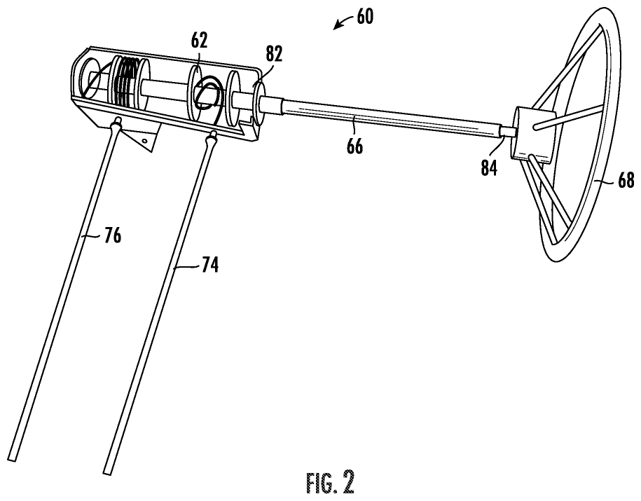

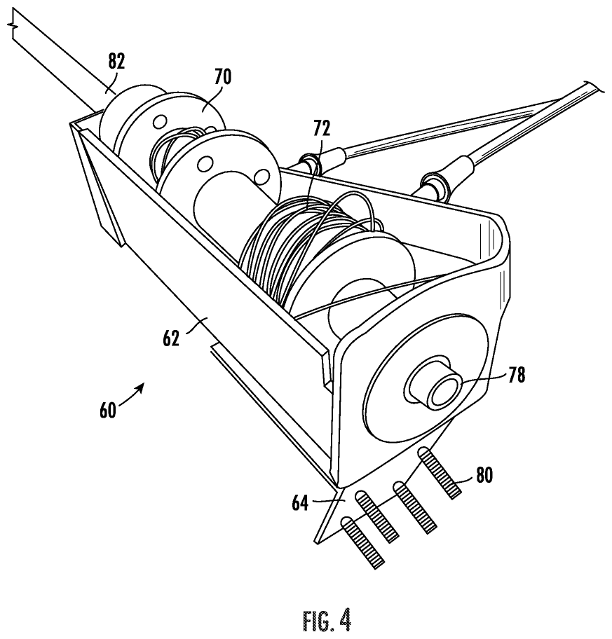

FIGS. 2-8 illustrate an exemplary vehicle auxiliary control apparatus suitable for incorporation into a motor vehicle 10.

The auxiliary control apparatus includes several independent assemblies, each of which provides passenger-side control of one of the basic vehicle driving functions, namely steering, braking, acceleration, and turn signaling.

FIGS. 2-5 illustrate an auxiliary steering assembly 60. The assembly includes a frame 62, mounting bracket 64, auxiliary steering shaft 66, auxiliary steering wheel 68, first and second cable spool assemblies 70, 72, and first and second cable assemblies 74, 76.

Frame 62 serves the function of positioning the auxiliary steering shaft 66 and other working parts. In the illustrated example, it is fabricated from welded plate or sheet steel. It includes one or more bearings 78 permitting the auxiliary steering shaft 66 to be rotatably mounted therein. As used herein, the term “bearing” refers generally to any structure that will locate auxiliary steering shaft 66 while permitting it to rotate reasonably free from friction. Examples of suitable bearings include concentric holes having a predetermined clearance, bushings, and/or rolling-element bearings.

The mounting bracket 64 provides a means for mounting the frame 62 to the motor vehicle 10. In the illustrated example, the mounting bracket 64 is a piece of plate steel with threaded studs 80 secured thereto. The mounting bracket 64 may be mounted, for example by inserting the studs through complementary holes (not shown) in the vehicle chassis or body and securing them with threaded nuts (not shown).

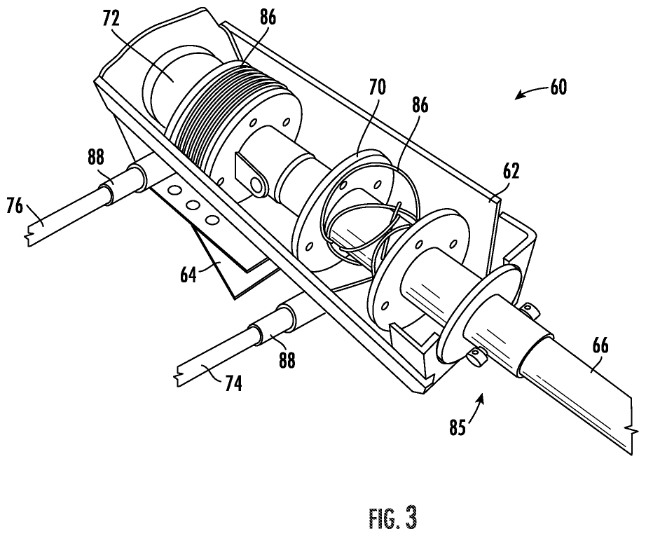

The auxiliary steering shaft 66 has a first end 82 mounted in the frame 62 and a second end 84 which carries the auxiliary steering wheel 68. Optionally, the auxiliary steering shaft 66 may be provided in two pieces joined by a quick release connection 85 such as the illustrated hitch pin and hairpin clip (FIG. 3). This permits the auxiliary steering shaft 66 to be quickly removed when not in use.

Each of the first and second cable assemblies 74, 76 comprises a cable 86 in a sheath 88.

The first cable spool assembly 70 includes a first spool mounted to the auxiliary steering shaft 66 within the frame 62. It is mounted in such a way that it will rotate with the auxiliary steering shaft 66 during use, but can be moved to adjust cable tension as necessary. For example, it may be mounted to the auxiliary steering shaft using one or more setscrews. One end of the cable 86 of the first cable assembly 74 is attached to the first cable spool assembly 70. In the illustrated example, this cable 86 is wound such that counterclockwise rotation of the auxiliary steering shaft 66 will wind the cable 86 onto the first cable spool assembly 70.

The second cable spool assembly 72 includes a second spool mounted to the auxiliary steering shaft 66 within the frame 62. It is mounted in such a way that it will rotate with the auxiliary steering shaft 66 during use, but can be moved to adjust cable tension as necessary. For example, it may be mounted to the auxiliary steering shaft using one or more setscrews. One end of the cable 86 of the second cable assembly 76 is attached to the second cable spool assembly 72. In the illustrated example, this cable 86 is wound such that clockwise rotation of the auxiliary steering shaft 66 will wind the cable 86 onto the second cable spool assembly 72.

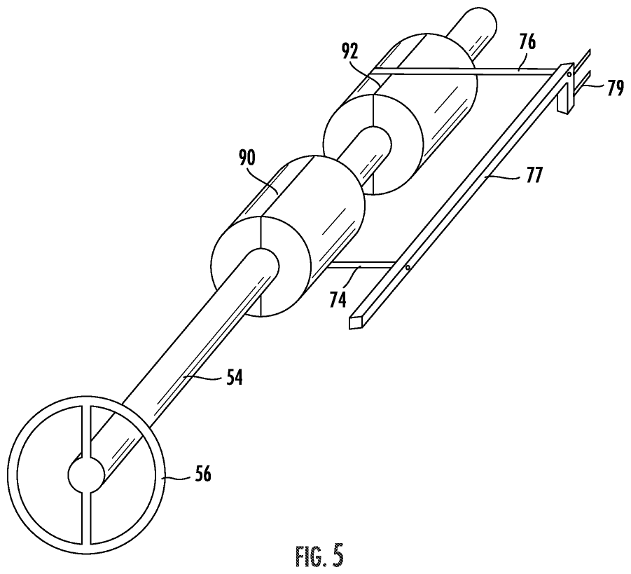

The opposite ends of the cable assemblies 74, 76 are coupled to the steering shaft 54 of vehicle 10. As seen in FIG. 5, first and second split spools 90, 92 may be attached to the steering shaft 54. They may be secured with bolts, worm clamps, or other suitable means.

One end of the cable of the first cable assembly 74 is attached to the first split spool 90. In the illustrated example, this cable is wound such that clockwise rotation of the steering shaft 54 will wind the cable onto the first split spool 90.

One end of the cable of the second cable assembly 60 is attached to the second splits pool 90. In the illustrated example, this cable is wound such that counterclockwise rotation of the steering shaft 54 will wind the cable onto the second split school 90.

The first and second cable assemblies 74, 76 may be routed between the two steering shaft in any convenient manner. They may be routed through the passenger compartment of the vehicle 10, for example under the dashboard, or they may be routed through the engine compartment. As shown in FIG. 5, the first and second cable assemblies 74, 76 may be routed through a support bracket 77 which may be mounted to the vehicle firewall or other rigid structure, for example with studs 79. The bracket 77 provides a rigid support and termination point for the cable assemblies.

Connected in this manner, turning the auxiliary steering wheel 68 in one direction (for example clockwise) will wind up one of the cables on the auxiliary steering shaft 66, causing it to apply tension to the corresponding split spool on the steering shaft 54, thus turning the steering shaft 54. At the same time, the other cable will unwind from the auxiliary steering shaft 66 and wind onto its corresponding split spool on the steering shaft 54. This will maintain the desired tension on both cables. Steering in the opposite direction is accomplished by turning the auxiliary steering wheel 68 in the opposite direction, causing the cables to wind and unwind on opposite spools.

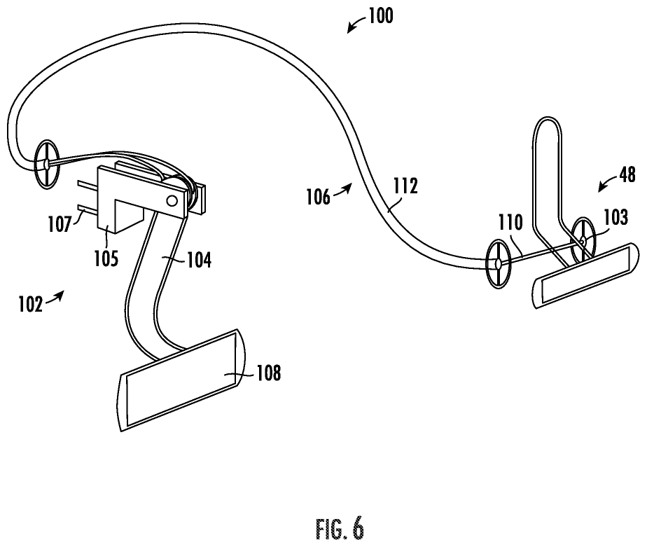

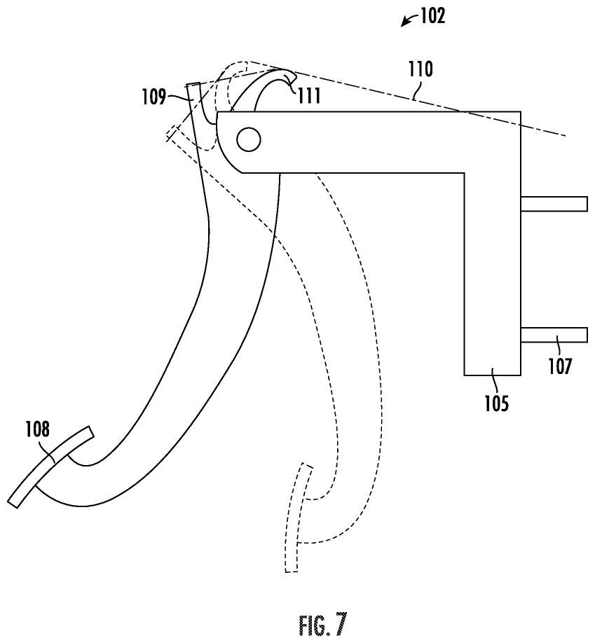

FIGS. 6 and 7 illustrate an auxiliary brake control assembly 100. It includes an auxiliary brake pedal assembly 102, a stock brake pedal coupler 103, and a brake pedal cable assembly 106.

The auxiliary brake pedal assembly 102 includes a brake pedal arm 104 pivotally coupled to a suitable bracket 105 for being mounted to the vehicle 10, for example using studs 107, and a pedal pad 108. The brake pedal cable assembly 106 includes a cable 110 slidably mounted in a sheath 112. One end of the cable 110 is connected to the brake pedal arm 104 at anchor 109 such that pressing on the pedal pad 108 will apply tension to the cable 110. The opposite end of the cable 110 is coupled to the vehicle's brake pedal assembly 48. The brake pedal cable assembly 106 may be routed in any convenient manner. For example, it may be routed under the dashboard, or through the engine compartment.

Configured in this manner, pressure on the auxiliary brake pedal assembly 102 will tension the brake pedal cable assembly 106, in turn applying a downward force to the vehicle's brake pedal assembly 48 and applying the brakes. The pivot end of the brake pedal arm 104 may include a shoe 111 which is a curved surface shaped similar to a cam. The shoe 111 is spaced away from the anchor 109 and is curved in such a way that, as the brake pedal is moved from a released position (solid lines in FIG. 7) towards an applied position (dashed lines in FIG. 7), the shoe 111 applies a lifting movement to the cable 110 in addition to the tension applied by the anchor 109. It has been found that this arrangement provides a more effective braking action than simply applying tension to the cable 110. Optionally, in order to overcome any friction that may be introduced into the system by the auxiliary brake control assembly 100, the return force of the stock brake pedal assembly 48 may be increased. For example, a stronger brake pedal return spring may be substituted for the vehicle's original brake pedal return spring, or a supplemental brake pedal return spring may be installed.

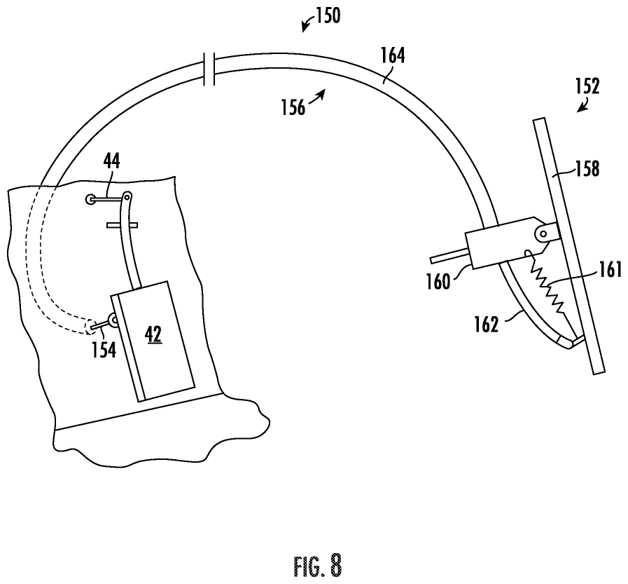

FIG. 8 illustrates an auxiliary accelerator control assembly 150. It includes an auxiliary accelerator pedal assembly 152, a stock accelerator pedal coupler 154, and an accelerator pedal cable assembly 156.

The auxiliary accelerator pedal assembly 152 includes an accelerator pedal 158 pivotally coupled to a suitable bracket 160 for being mounted to the vehicle 10. A return spring 161 is connected between the accelerator pedal 158 and the bracket 160. The accelerator pedal cable assembly 156 includes a cable 162 slidably mounted in a sheath 164. One end of the cable 162 is connected to the accelerator pedal 158 such that pressing on the pedal will apply tension to the cable 162. The opposite end of the cable 162 is coupled to the vehicle's accelerator pedal assembly 42. The accelerator pedal cable assembly 156 may be routed in any convenient manner. For example, it may be routed under the dashboard, or through the engine compartment.

Configured in this manner, pressure on the auxiliary accelerator pedal assembly 152 will tension the accelerator pedal cable 156, in turn applying a downward force of the vehicle's accelerator pedal assembly 42 and increasing the throttle opening.

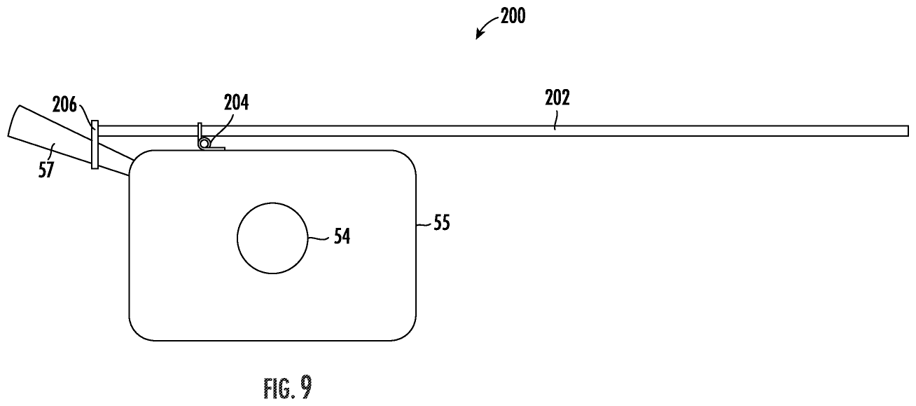

FIG. 9 illustrates a turn signal control assembly 200. It includes a lever 202 which may be made from bar or rod stock or similar material, coupled to the vehicle's stock steering column 55 using a hinge 204. The hinge may be attached with fasteners such as blind rivets or screws. One end of the lever 202 includes a circular or oval loop 206 which passes over the vehicle's stock turn signal lever 57. The other end of the lever 202 extends out sufficiently far away from the steering column 55 that a person can reach it from the passenger seat 22. In use, pivoting the lever 202 about the hinge 204 will cause the turn signal lever 57 to operate.

The foregoing has described a vehicle auxiliary control kit. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A vehicle auxiliary control apparatus, comprising:
an auxiliary steering assembly, including:
a frame;
an auxiliary steering shaft mounted for rotation in the frame;
an auxiliary steering wheel mounted to the auxiliary steering shaft;
first and second cable spool assemblies mounted to the auxiliary steering shaft; and
first and second cable assemblies coupled to the first and second cable spool assemblies, respectively; and
coupling means for coupling the first and second cable assemblies to a stock steering shaft of a motor vehicle, such that rotation of the auxiliary steering shaft causes rotation of the motor vehicle steering shaft.

2. The apparatus of claim 1, wherein the coupling means comprise first and second split spools configured to be attached to the stock steering shaft and to have the first and second cable assemblies connected thereto.

3. The apparatus of claim 1, further comprising:
an auxiliary brake control assembly, including:
an auxiliary brake pedal assembly;
a stock brake pedal coupler configured to be coupled to a stock brake pedal assembly of the motor vehicle; and
a brake pedal cable assembly interconnecting the auxiliary brake pedal assembly land the stock brake pedal coupler.

4. The apparatus of claim 3, wherein the auxiliary brake pedal assembly includes:
a bracket; and
a brake pedal arm pivotally connected to the bracket, wherein a pivot end of the brake pedal arm includes an anchor to which the brake pedal cable assembly is connected and a shoe which is spaced away from the anchor, wherein the shoe is curved in such a way that, as the auxiliary brake pedal is moved from a released position towards an applied position, the shoe will apply a lifting movement to the cable in addition a tension force.

5. The apparatus of claim 3, further comprising a replacement brake pedal return spring be substituted for an original brake pedal return spring of the stock brake pedal.

6. The apparatus of claim 1, further comprising:
an auxiliary accelerator control assembly including:
an auxiliary accelerator pedal assembly;
a stock accelerator pedal coupler, and
an accelerator pedal cable assembly interconnecting the accelerator pedal assembly and the stock accelerator pedal coupler.

7. The apparatus of claim 1, further comprising:
a turn signal control assembly, including:
a lever;
a hinge attached to the lever and configured to be coupled to a stock steering column of the motor vehicle; and
a loop mounted to one end of the lever which is sized to which pass over a stock turn signal lever of the motor vehicle.

8. A method of providing auxiliary control of a motor vehicle of the type including a chassis riding on at least one wheel assembly which is driven by a primer mover and is provided with a brake, the method comprising:
providing an auxiliary steering assembly, including a frame, an auxiliary steering shaft mounted for rotation in the frame, and auxiliary steering wheel coupled to the auxiliary steering shaft, first and second cable spool assemblies mounted to the auxiliary steering shaft, and first and second cable assemblies coupled to the first and second cable spool assemblies, respectively;
attaching the frame to the vehicle;
coupling the cable assemblies to a stock steering shaft of the motor vehicle, in a configuration such that rotation of the auxiliary steering shaft causes rotation of the stock steering shaft.

9. The method of claim 8 further comprising:
attaching first and second splits spools to the stock steering shaft;
connecting the first and second cable assemblies to the first and second split spools, respectively.

10. The method of claim 8 further comprising:
providing an auxiliary brake control assembly, including: an auxiliary brake pedal assembly, a stock brake pedal coupler, and a brake pedal cable assembly interconnecting the auxiliary brake pedal assembly and the stock brake coupler;
attaching the auxiliary brake pedal assembly to the vehicle; and
coupling the stock brake pedal coupler to a stock brake pedal assembly of the motor vehicle, in a configuration such that foot pressure on the auxiliary brake pedal assembly will apply tension force to the brake pedal cable assembly, in turn applying a downward force to the stock brake pedal assembly.

11. The method of claim 10, wherein a wherein the brake pedal assembly includes a shoe which is curved in such a way that, as the auxiliary brake pedal is moved from a released position towards an applied position, the shoe will apply a lifting movement to the cable in addition the tension.

12. The method of claim 10, further comprising increasing a return force of the stock brake pedal assembly by installing a supplemental brake pedal return spring to the stock brake pedal assembly, or by replacing an original brake pedal return spring of the stock brake pedal assembly with a stronger brake pedal return spring.

13. The method of claim 8, further comprising:
providing an auxiliary accelerator control assembly, including: an auxiliary accelerator pedal assembly, a stock accelerator pedal coupler, and an accelerator pedal cable assembly;
attaching the auxiliary accelerator pedal assembly to the vehicle; and
coupling the stock accelerator pedal coupler to a stock accelerator pedal assembly of the motor vehicle, in a configuration such that pressure on the auxiliary accelerator pedal assembly will tension the accelerator pedal cable, in turn applying a downward force of the stock accelerator pedal assembly.

14. A motor vehicle, comprising:
a chassis supported on at least one wheel assembly;
a steering mechanism coupled to the at least one wheel assembly;
a stock steering shaft coupled to the steering mechanism;
a prime mover operable to drive the at least one wheel assembly;
a stock accelerator pedal assembly operable to control a power output of the prime mover;
a brake operable to slow the at least one wheel assembly;
a stock brake pedal assembly operable to cause operation of the brake; and
an auxiliary steering assembly; including:
a frame mounted to the motor vehicle;
an auxiliary steering shaft mounted for rotation in the frame;
an auxiliary steering wheel mounted to the auxiliary steering shaft;
first and second cable spool assemblies mounted to the auxiliary steering shaft; and
first and second cable assemblies, which are coupled to the first and second cable spool assemblies, respectively, and to the stock steering shaft, and a configuration such that rotation of the auxiliary steering shaft causes rotation of the stock vehicle steering shaft.

15. The motor vehicle of claim 14, further comprising:
an auxiliary brake control assembly, including:
an auxiliary brake pedal assembly;
a stock brake pedal coupler; and
a brake pedal cable assembly, wherein the stock brake pedal coupler is coupled to the stock brake pedal assembly, in a configuration such that foot pressure on the auxiliary brake pedal assembly will apply tension force to the brake pedal cable assembly, in turn applying a downward force to the stock brake pedal assembly.

16. The motor vehicle of claim 14, further comprising:
an auxiliary accelerator control assembly, including:
an auxiliary accelerator pedal assembly;
a stock accelerator pedal coupler; and
an accelerator pedal cable assembly, wherein the stock accelerator pedal coupler is coupled to the stock accelerator pedal assembly, in a configuration such that pressure on the auxiliary accelerator pedal assembly will tension the accelerator pedal cable, in turn applying a downward force of the stock accelerator pedal assembly.

17. The motor vehicle of claim 14, further comprising:
a turn signal control assembly, including:
a lever;
a hinge attached to the lever and configured to be coupled to a stock steering column of the motor vehicle; and
a loop mounted to one end of the lever which is sized to which pass over a stock turn signal lever of the motor vehicle.
